(19) United States
(12) Patent Application Publication
(10) Pub. No.: US 2017/0270812 A1
(43) Pub. Date: Sep. 21, 2017

(54) METHOD FOR LEARNING ASSESSMENT

(71) Applicant: WEN TSUNG CHU, CHIAYI CITY (TW)

(72) Inventor: WEN TSUNG CHU, CHIAYI CITY (TW)

(21) Appl. No.: 15/071,236

(22) Filed: Mar. 16, 2016

(51) Int. Cl. G09B 7/04; G09B 5/02

(52) U.S. Cl. CPC G09B 7/04; G09B 5/02

(57) ABSTRACT

The present disclosure provides a method for learning assessment, including following steps of: (A) when a course list including sub-course units and assessment result information from a server end is displayed at a user end, generating a learning request by the user end, and transmitting the learning request to the server end; (B) transmitting a course catalog including test question assessment categories to the user end by the server end; (C) generating an assessment request by the user end, and transmitting the assessment request to the server end; (D) transmitting assessment test questions corresponding to the assessment request to the user end by the server end; (E) generating answer content related to the questions by the user end, and transmitting the content to the server end; and (F) generating an assessment result according to the content by the server end, and updating the assessment result information according to the result.

### FIELD OF THE INVENTION

The present disclosure is related to a method for learning assessment, and particularly, to a method for online learning assessment.

### BACKGROUND

With the rise of Internet and the progress of information technology, computers and Internet make tremendous changes to human life and work. In education, the traditional classroom-based learning from face-to-face teaching has also evolved to the digital learning based on an Internet platform. The digital learning can be performed anywhere and anytime; in other words, time and places for digital learning are not limited to those for the traditional learning. Only connection to Internet is needed to perform digital learning without considering the teacher's schedule and traffic to the location of the classroom.

Currently, there have been more and more companies to develop digital learning industry, and have proposed convenient digital learning platforms and systems to provide production, delivery and management of courses. The function of digital learning platform is primarily presented by teacher's design and upload of teaching content and plans of learning activities, so as to provide services such as management of teaching, participation of learning and etc.

The teaching function of digital learning platform deeply affects learning effects of users. Thus, it is always a common goal for the government and community to establish and integrate learning environment of good quality by effectively using the teaching function provided by the digital learning platform to further activate goals of education and improve quality of teaching.

The current digital learning platform provides a learner with a respective test assessment for each learning unit, and then provides a respective score to the learner of the course for reference according to a result of the respective assessment. Further, the learner's respective assessment results corresponding to each learning units are distributed in different assessment web pages, such that the learner cannot browse all learning results at one time. Hence, it is necessary to develop a solution for the above problems.

Therefore, it is a problem to be solved that based on a learner's point of view, the learner's respective learning effects corresponding to each learning unit are directly presented and a digital learning platform is provided to help the learner enhance learning efficacy.

### BRIEF SUMMARY OF THE INVENTION

Accordingly, it is an object of the present disclosure to provide a method for learning assessment to effectively help a learner enhance learning efficiency and to directly present a learner's learning effects.

In the present disclosure, the method for learning assessment includes the following steps of: (A) when a course list related to at least one subject from a server end is displayed at a user end, wherein the course list includes a plurality of course units respectively having a plurality of sub-course units and assessment result information corresponding to a specific user and related to the sub-course units, generating a learning request to one of the sub-course units through a first input operation by the user end, and transmitting the learning request to the server end through a communication network; (B) when the learning request from the user end is received, transmitting a course catalog corresponding to the learning request to the user end through the communication network by the server end, wherein the course catalog includes a plurality of kinds of test question assessments; (C) after the course catalog from the server end is received and displayed at the user end, generating an assessment request to one of the kinds of test question assessments through a second input operation by the user end, and transmitting the assessment request to the server end through the communication network; (D) when the assessment request from the user end is received, transmitting a plurality of assessment test questions corresponding to the assessment request to the user end through the communication network by the server end; (E) when the assessment test questions are received and displayed at the user end, generating answer content corresponding to the assessment test questions through a third input operation by the user end, and transmitting the answer content to the server end through the communication network; and (F) when the answer content from the user end is received, generating an assessment result corresponding to the assessment request according to predetermined standard answer content corresponding to the assessment test questions and the answer content, and updating the assessment result information according to the assessment result.

The present disclosure has the effect that the course list including the assessment result information related to the sub-course units is displayed at the user end, and the assessment result information is updated according to the assessment result, such that the learner can browse all assessment outcomes directly on the course list displayed at the user end, and thus the usability is enhanced.

### BRIEF DESCRIPTION OF THE DRAWINGS

Aspects of the present disclosure are best understood from the following detailed description when read with the accompanying figures.

FIG. 1 is a system block diagram showing a user end, a server end and a service end in a method for learning assessment according to an embodiment of the present disclosure.

FIG. 2 is a flow chart illustrating transmission of a course list to a user end in a method for learning assessment according to an embodiment of the present disclosure.

FIG. 3 is a flow chart illustrating transmission of course video content corresponding to a playback request to a user end in a method for learning assessment according to an embodiment of the present disclosure.

FIG. 4 is a flow chart illustrating transmission of next diagnostic test questions related to a diagnosis request to a user end in a method for learning assessment according to an embodiment of the present disclosure.

FIG. 5 is a flow chart illustrating transmission of another diagnostic test questions related to the diagnosis request in a method for learning assessment according to an embodiment of the present disclosure.

FIG. 6 is a flow chart illustrating transmission of multiple assessment test questions corresponding to an assessment request to a user end according to an embodiment of the present disclosure.

FIG. 7 is a schematic view showing the transmitted course list in a method for learning assessment according to an embodiment of the present disclosure.

FIG. 8 is a schematic view showing the transmitted course catalog in a method for learning assessment according to an embodiment of the present disclosure.

FIG. 9 is a schematic view showing the displayed diagnostic scores in a method for learning assessment according to an embodiment of the present disclosure.

### DETAILED DESCRIPTION

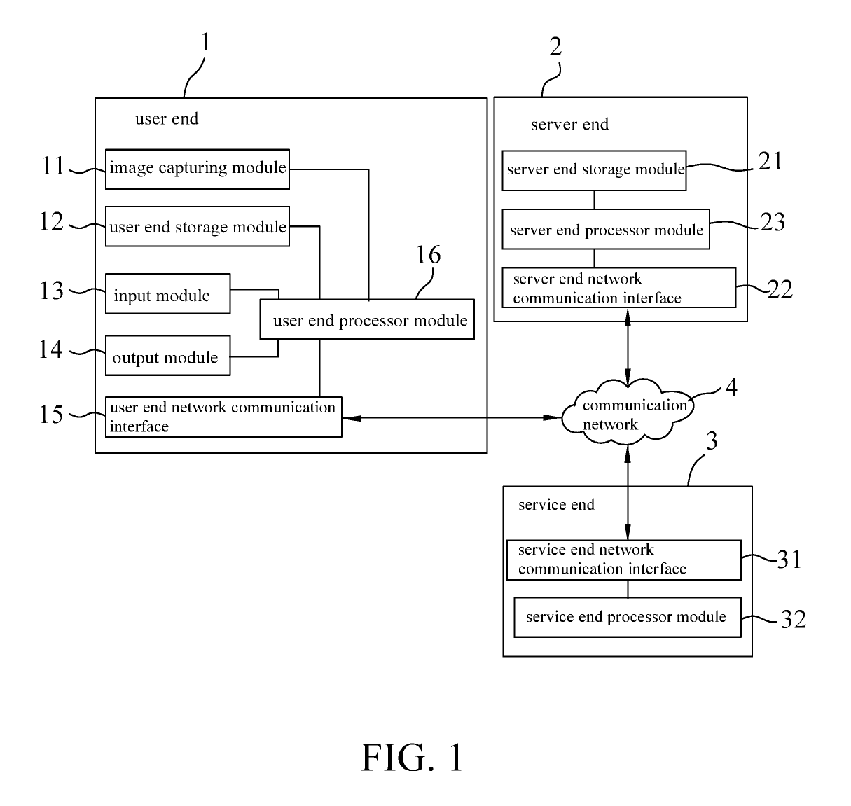

Referring to FIG. 1, the method for learning assessment of the present disclosure can be implemented by a user end 1, a server end 2 and a service end 3.

The user end 1 includes an image capturing module 11, a user end storage module 12, an input module 13, an output module 14, a user end network communication interface 15 for connecting to a communication network 4, and a user end processor module 16 for electrically connecting to the image capturing module 11, the user end storage module 12, the input module 13, the output module 14 and the user end network communication interface 15, wherein an application program (not shown) is stored in the user end storage module 12.

The server end 2 includes a server end storage module 21, a server end network communication interface 22 for connecting to the communication network 4, and a server end processor module 23 for electrically connecting to the server end storage module 21 and the server end network communication interface 22, wherein a learning assessment program (not shown) is stored in the server end storage module 21.

The service end 3 includes a service end network communication interface 31 for connecting to the communication network 4, and a service end processor module 32 for electrically connecting to the service end network communication interface 31.

It is to be noted that in the present embodiment, at the user end 1, the application program can be executed by the user end processor module 16 to implement the method for learning assessment of the present disclosure. However, in other embodiments, at the user end 1, a browser executed in the user end processor module 16 is connected to the server end 2 to implement the method for learning assessment of the present disclosure, and the method for learning assessment of the present disclosure is not limited to the embodiments. It is well-known by persons skilled in the art that the mutual operation between the user end 1 and the server end 2 is implemented by executing the application program and the browser, and thus is not described in detail herein.

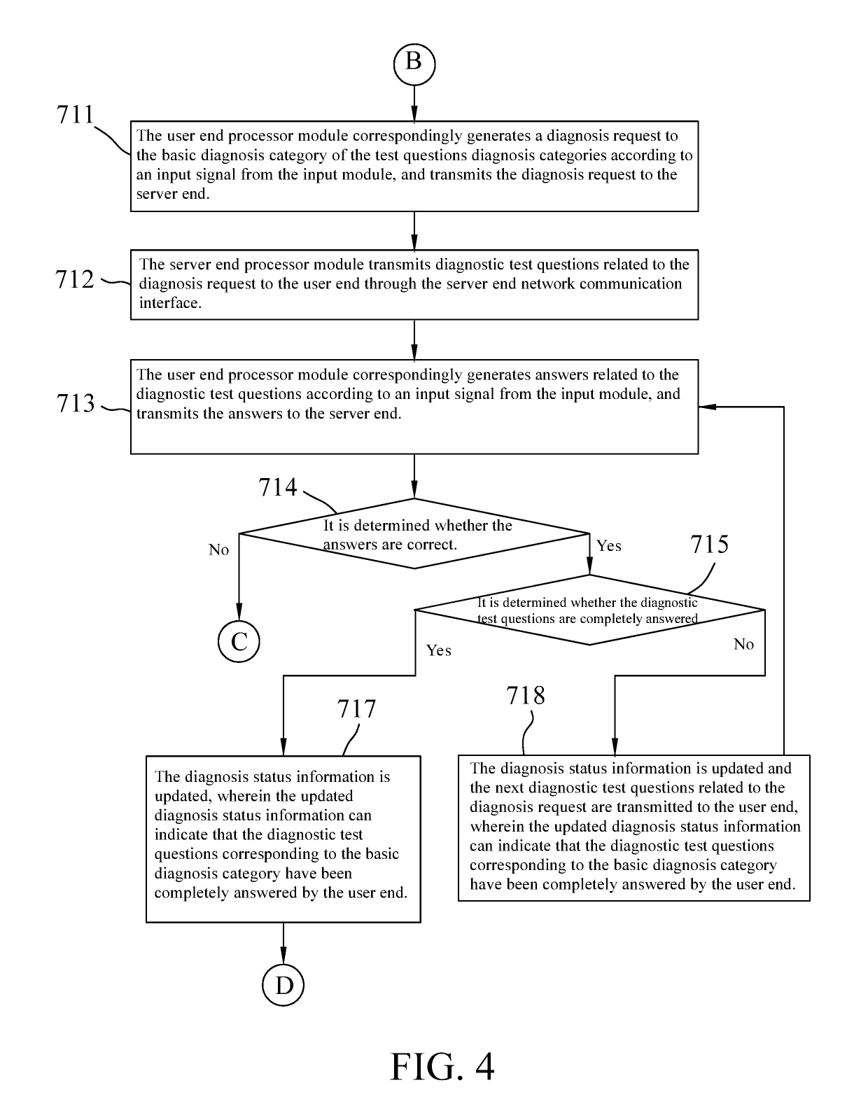

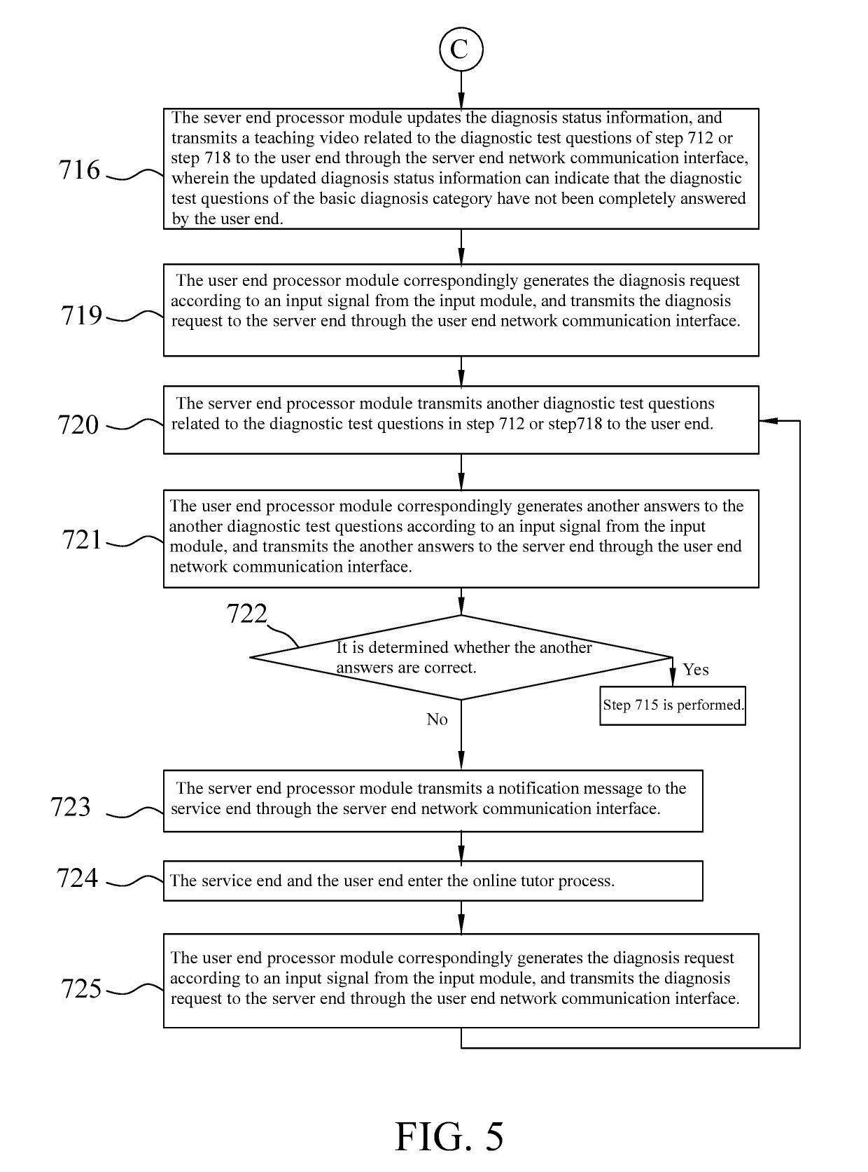

Referring to FIG. 1 to FIG. 6, the detailed operations among components of the user end 1, the server end 2 and the service end 3 are described according to embodiments of the method for learning assessment of the present disclosure, and the method includes the following steps.

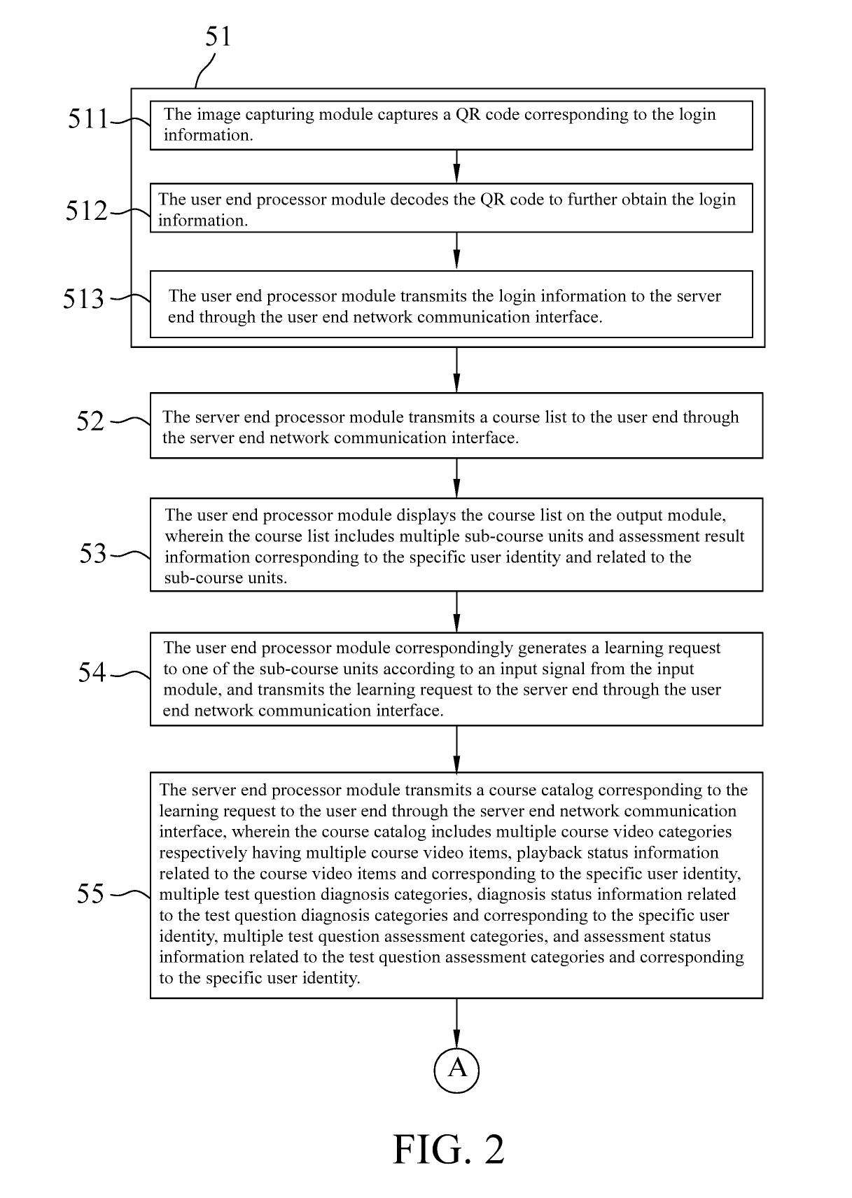

Referring to FIG. 1 and FIG. 2, as shown in step 51, the application program is executed by the user end processor module 16 for transmitting login information corresponding to a specific user identity to the server end 2 through the user end network communication interface 15.

It is to be noted that step 51 further includes the detailed procedure of sub-step 511 to sub-step 513.

As shown in sub-step 511, when the application program is executed by the user end processor module 16, the user end processor module 16 uses the image capturing module 11 to capture a QR code corresponding to the login information.

As shown in sub-step 512, the application program is executed by the user end processor module 16 for decoding the QR code to further obtain the login information.

As shown in sub-step 513, the application program is executed by the user end processor module 16 for transmitting the login information obtained from sub-step 512 to the server end network communication interface 22 through the user end network communication interface 15.

It is to be noted that in this embodiment, the login information is obtained from the QR code; however, in other embodiments of the present disclosure, the application program is executed by the user end processor module 16 for correspondingly generating the login information according to the input signal from the input module 13, and the present disclosure is not limited to disclosure of the embodiments.

As shown in step 52, when the login information from the user end 1 is received by the server end processor module 23 through the server end network communication interface 22, the learning assessment program is executed by the server end processor module 23 for transmitting a course list related to at least one subject to the user end network communication interface 15 through the server end network communication interface 22.

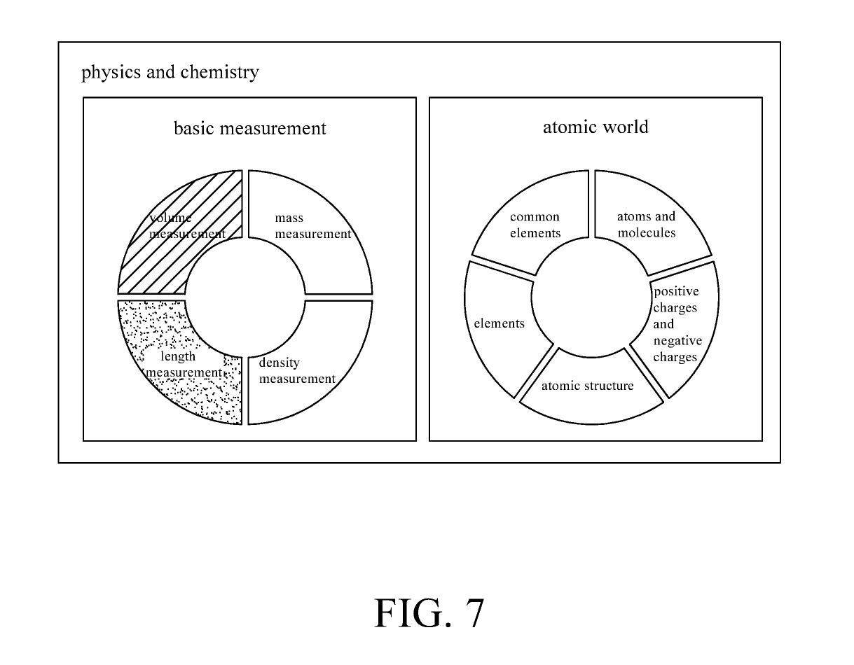

As shown in step 53, when the course list from the server end 2 is received by the user end processor module 16 through the user end network communication interface 15, the application program is executed by the user end processor module 16 for displaying the course list on the output module 14, wherein the course list (referring to FIG. 7) includes multiple course units respectively having multiple sub-course units and assessment result information corresponding to the specific user identity and related to the sub-course units.

As shown in step 54, the application program is executed by the user end processor module 16 for correspondingly generating a learning request to one of the sub-course units according to a first input signal from the input module 13, and transmitting the learning request to the server end network communication interface 22 through the user end network communication interface 15.

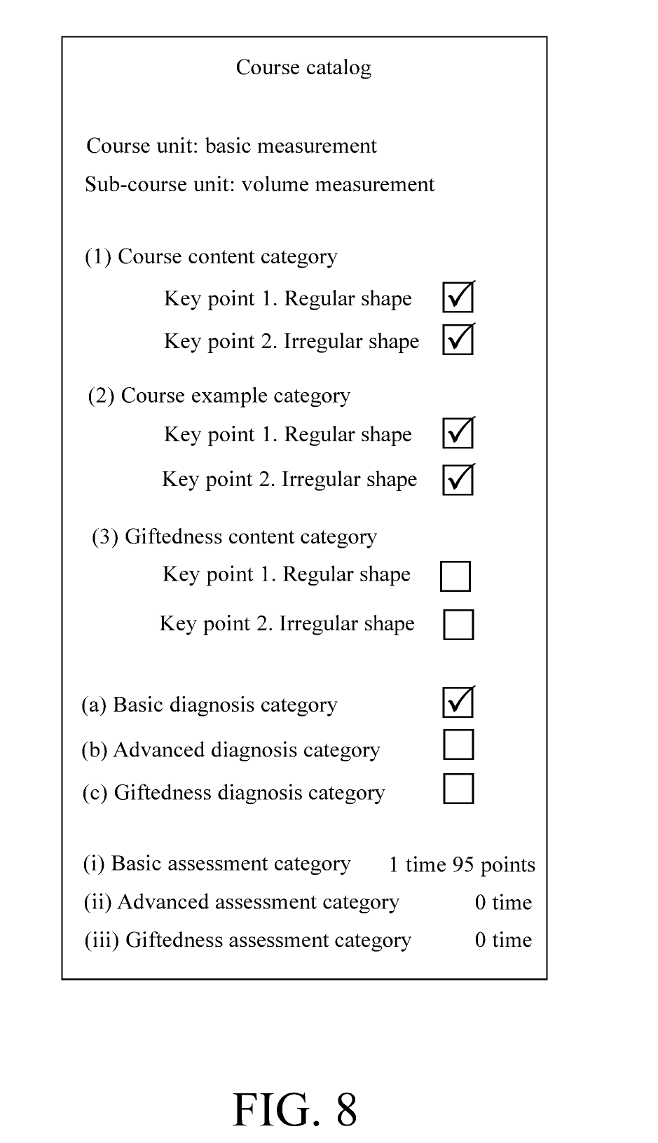

As shown in step 55, when the learning request from the user end 1 is received by the server end processor module 23 through the server end network communication interface 22, the learning assessment program is executed by the server end processor module 23 for transmitting a course catalog corresponding to the learning request to the user end 1 through the server end network communication interface 22. The course catalog includes multiple course video categories respectively having multiple course video items, playback status information related to the course video items and corresponding to the specific user identity, multiple test question diagnosis categories, diagnosis status information related to the test question diagnosis categories and corresponding to the specific user identity, multiple test question assessment categories, and assessment status information related to the test question assessment categories and corresponding to the specific user identity. The course video categories are a course content category, a course example category and a giftedness content category, respectively. The test question diagnosis categories are a basic diagnosis category, an advanced diagnosis category, and a giftedness diagnosis category, respectively. The test question assessment categories are a basic assessment category, an advanced assessment category, and a giftedness assessment category, respectively (referring to FIG. 8).

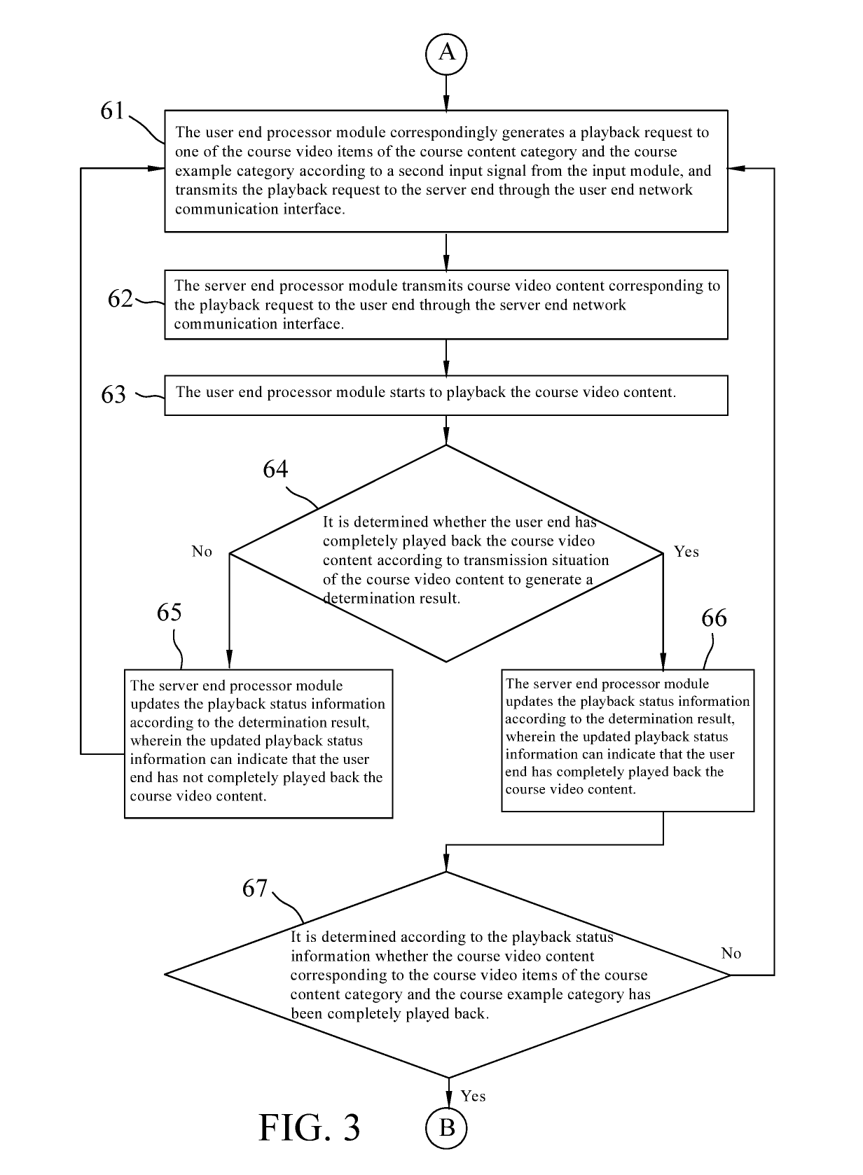

Referring to FIG. 1 and FIG. 3, as shown in step 61, when the course catalog from the server end 2 is received by the user end processor module 16 through the user end network communication interface 15 and the application program is executed to display the course catalog on the output module 14, the application program is executed by the user end processor module 16 for correspondingly generating a playback request to one of the course video items of the course content category and the course example category according to a second input signal from the input module 13, and transmitting the playback request to the server end network communication interface 22 through the user end network communication interface 15.

As shown in step 62, when the playback request from the user end 1 is received by the server end processor module 23 through the server end network communication interface 22, the learning assessment program is executed by the server end processor module 23 for transmitting course video content corresponding to the playback request through the server end network communication interface 22 to the user end network communication interface 15.

As shown in step 63, when the course video content from the server end 2 is received by the user end processor module 16 through the user end network communication interface 15, the application program is executed by the user end processor module 16 to start playing back the course video content.

As shown in step 64, the learning assessment program is executed by the server end processor module 23 for determining whether the user end 1 has completely played back the course video content according to transmission situation of the course video content to generate a determination result. When the server end processor module 23 determines that the user end 1 has not completely played back the course video content, step 65 is performed; when the server end processor module 23 determines that the user end 1 has completely played back the course video content, step 66 is performed.

As shown in step 65, the learning assessment program is executed by the server end processor module 23 for updating the playback status information according to the determination result, wherein the updated playback status information can indicate that the user end 1 has not completely played back the course video content, and step 61 is performed. In step 61, when the application program is executed by the user end processor module 16 for correspondingly generating anther playback request to the same course video item according to a third input signal from the input module 13, in step 62, the learning assessment program is executed by the server end processor module 23 for transmitting the course video content corresponding to the another playback request to the user end network communication interface 15 through the server end network communication interface 22, wherein the server end 2 continually transmits the course video content which has not been completely played back last time at the user end 1, to the user end 1. In other words, the course video content corresponding to the another playback request is the course video content, which has not been completely played back last time at the user end 1. In this embodiment, the playback status information is presented by different pattern notes. For example, a first pattern indicates that the course video content has been completely played back by the user end 1, and a second pattern indicates that the course video content has not been completely played back by the user end 1 (referring to FIG. 7). However, in other embodiments of the present disclosure, the presentation of the playback status information can be, but not limited to, text notes or texts with different colors.

As shown in step 66, the learning assessment program is executed by the server end processor module 23 for updating the playback status information according to the determination result, wherein the updated playback status information can indicate that the course video content has been completely played back by the user end 1.

It is to be noted that in this embodiment, in steps 65 and 66, after the server end processor module 23 updates the playback status information, the learning assessment program is executed by the server end processor module 23 for transmitting a playback progress message related to the playback status information through the server end network communication interface 22 to a control end (not shown) owned by a parent or a teacher of the learner, such that the parent or teacher of the learner can know the learner's learning assessment situation.

As shown in step 67, the learning assessment program is executed by the server end processor module 23 for determining whether the course video content, which is corresponding to the course video items of the course content category and the course example category according to the playback status information, has been completely played back. When the server end processor module 23 in step 67 determines that the course video content of the course video items has not been completely played back by the user end 1, step 61 is performed; when the server end processor module 23 in step 67 determines that the course video content of the course video items has been completely played back by the user end 1, step 711 is performed.

Referring to FIGS. 1, 4 and 5, as shown in step 711, when the course catalog from the server end 2 is received by the user end processor module 16 through the user end network communication interface 15 and the application program is executed for displaying the course catalog on the output module 14, the application program is executed by the user end processor module 16 for correspondingly generating a diagnosis request to the basic diagnosis category of the test question diagnosis categories according to a fourth input signal from the input module 13, and transmitting the diagnosis request to the server end network communication interface 22 through the user end network communication interface 15.

It is to be noted that in this embodiment, only when the course video content of the course video items has been completely played back by the user end 1, the application program is executed by the user end processor module 16 for generating a diagnosis request to the basic diagnosis category of the test question diagnosis categories; however, in other embodiments of the present disclosure, depending on the needs of the learner, the application program can also be directly executed by the user end processor module 16 for generating a diagnosis request to the basic diagnosis category of the test question diagnosis categories without waiting for complete playback of the course video content, and the present disclosure is not limited to this embodiment.

As shown in step 712, when the diagnosis request from the user end 1 is received by the server end processor module 23 through the server end network communication interface 22, the learning assessment program is executed by the server end processor module 23 for transmitting diagnostic test questions related to the diagnosis request to the user end network communication interface 15 through the server end network communication interface 22.

As shown in step 713, when the diagnostic test questions from the server end 2 are received by the user end processor module 16 through the user end network communication interface 15, and the application program is executed for displaying the diagnostic test questions on the output module 14, the application program is executed by the user end processor module 16 for correspondingly generating answers related to the diagnostic test questions according to a fifth input signal from the input module 13, and transmitting the answers to the server end network communication interface 22 through the user end network communication interface 15.

As shown in step 714, when the answers from the user end 1 are received by the server end processor module 23 through the server end network communication interface 22, the learning assessment program is executed by the server end processor module 23 for determining whether the answers are correct according to standard answers corresponding to the diagnostic test questions. When it is determined that the answers are correct, step 715 is performed; when it is determined that the answers are incorrect, step 716 is performed.

As shown in step 715, the learning assessment program is executed by the server end processor module 23 for determining whether the diagnostic test questions corresponding to the basic diagnosis category are completely answered to generate a diagnosis result. When the diagnosis result indicates that the diagnostic test questions of the basic diagnosis category are completely answered, step 717 is performed; when the diagnosis result indicates that the diagnostic test questions of the basic diagnosis category are not completely answered, step 718 is performed.

As shown in step 718, the learning assessment program is executed by the server end processor module 23 for updating the diagnosis status information according to the diagnosis result and transmitting next diagnostic test questions related to the diagnosis request to the user end network communication interface 15, and then step 713 is performed. The updated diagnosis status information can indicate that the diagnostic test questions of the basic diagnosis category have not been completely answered by the user end 1. In this embodiment, the diagnosis status information is presented by different pattern notes. For example, when the diagnostic test questions of the basic diagnosis category have been completely answered by the user end 1, a first pattern is used for indicating that the user end 1 has done with the diagnostic test questions; when the diagnostic test questions of the basic diagnosis category have not been completely answered by the user end 1, a second pattern is used for indicating that the user end 1 has not done with the diagnostic test questions (referring to FIG. 7). However, in other embodiments of the present disclosure, the presentation of the diagnosis status information can be, but not limited to, text notes or texts with different colors.

As shown in step 716, the learning assessment program is executed by the sever end processor module 23 for updating the diagnosis status information, and transmitting a teaching video related to the diagnostic test questions of step 712 to the user end network communication interface 15 through the server end network communication interface 22, such that the teaching video is played back by the user end 1. The updated diagnosis status information can indicate that the diagnostic test questions of the basic diagnosis category have not been completely answered by the user end 1.

As shown in step 719, when the teaching video has been completely played back by the user end processor module 16, the application program is executed by the user end processor module 16 for correspondingly generating the diagnosis request according to a sixth input signal from the input module 13, and transmitting the diagnosis request to the server end network communication interface 22 through the user end network communication interface 15, wherein after the teaching video has been completely played back by the user end 1, the diagnosis request is generated due to further diagnosis to be performed.

As shown in step 720, when the diagnosis request from the user end 1 is received by the server end processor module 23 through the server end network communication interface 22, the learning assessment program is executed by the server end processor module 23 for transmitting the diagnostic test questions related to the diagnostic test questions in step 712 to the user end 1.

As shown in step 721, when another diagnostic test questions from the server end 2 are received by the user end processor module 16 through the user end network communication interface 15, and the application program is executed for displaying the another diagnostic test questions on the output module 14, the application program is executed by the user end processor module 16 for correspondingly generating another answers to the another diagnostic test questions according to a seventh input signal from the input module 13, and transmitting the another answers to the server end network communication interface 22 through the user end network communication interface 15.

As shown in step 722, when the another answers from the user end 1 are received by the server end processor module 23 through the server end network communication interface 22, the learning assessment program is executed by the server end processor module 23 for determining whether the another answers are another standard answers according to the another standard answers corresponding to the diagnostic test questions. When it is determined that the another answers are correct, step 715 is performed; when it is determined that the another answers are incorrect, step 723 is performed.

As shown in step 723, the learning assessment program is executed by the server end processor module 23 for transmitting a notification message to the service end network communication interface 31 through the server end network communication interface 22, wherein the service end 3 is used for providing a conventional online tutor process.

As shown in step 724, the service end 3 and the user end 1 enter the online tutor process, for example, through online messaging software such as Skybe, for instant video teaching. However, it is not the key point of the present disclosure to use the conventional online tutor process, which is not described in detail herein.

As shown in step 725, the application program is executed by the user end processor module 16 for correspondingly generating the diagnosis request according to an eighth input signal from the input module 13, and transmitting the diagnosis request to the server end network communication interface 22 through the user end network communication interface 15, wherein after the online tutor process has been completed by the user end 1, the diagnosis request is generated due to further diagnosis to be performed, and step 720 is performed.

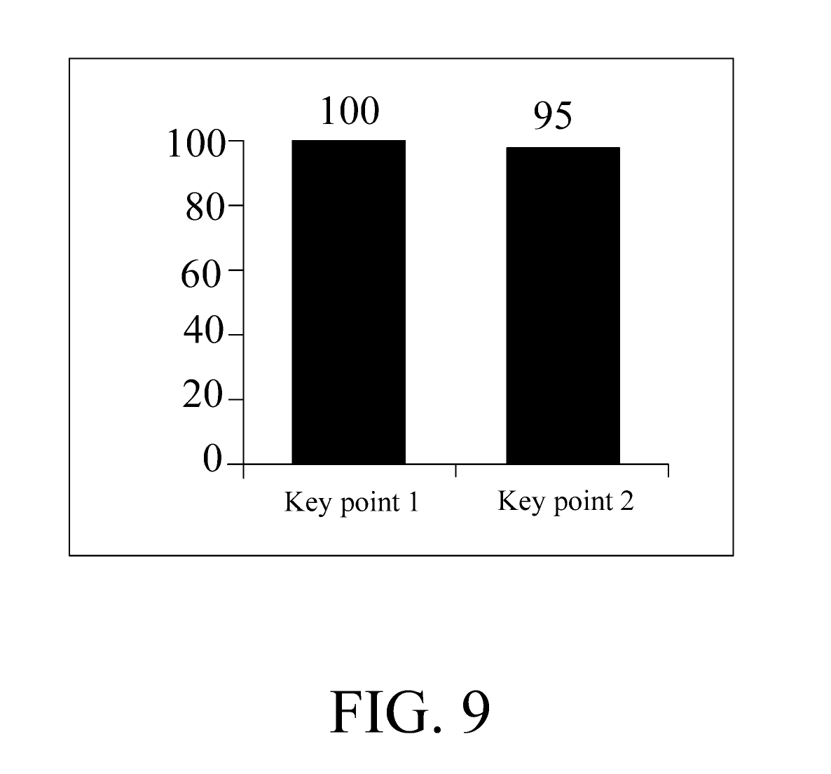

As shown in step 717, the learning assessment program is executed by the server end processor module 23 for updating the diagnosis status information according to the diagnosis result, and calculating multiple diagnosis scores corresponding to the course video items. The updated diagnosis status information can indicate that the diagnostic test questions corresponding to the basic diagnosis category have been completely answered by the user end 1. For example, the diagnostic test questions corresponding to the basic diagnosis category include multiple diagnostic test questions related to different course video items. In FIG. 8, for example, the course video items include a key point 1 and a key point 2, the number of the diagnostic test questions related to the key point 1 is, for example, 3 (Q1-1, Q1-2 and Q1-3), and the number of the diagnostic test questions related to the key point 2 is, for example, 4 (Q1-1, Q1-2, Q1-3 and Q1-4). When the scores for the three diagnostic test questions about the key point 1 are 30 points, 30 point and 40 point, and it is determined in step 714 that the answers to the three diagnostic test questions about the key point 1 are all correct, and the diagnosis score of the key point 1 is 30+30+40=100. When each of the scores of the diagnostic test questions about the key point 2 is 25 points, it is determined in step 714 that the answers to three (Q1-1, Q1-2 [symbol] Q1-3) of the diagnostic test questions about the key point 2 are correct, and it is determined in step 722 that the answer to another diagnostic test question (Q1-4′) related to the left diagnostic test question (Q1-4) about the key point 2 is correct, the diagnosis score of the key point 2 is 25+25+25+25×0.8=95. When it is determined in step 722 that the answer is correct, the score of the diagnostic test question (Q1-4) should be multiplied by a value such as 0.8. When the application program is executed by the user end processor module 16 for correspondingly generating a query request to the diagnosis score according to a ninth signal from the input module 13, the application program is executed by the user end processor module 16 for displaying the diagnosis score in a chart on the output module 14 (referring to FIG. 9).

It is to be noted that in this embodiment, in steps 716, 717 and 718, after the server end processor module 23 updates the diagnosis status information, the learning assessment program is executed by the server end processor module 23 for transmitting a diagnosis progress message related to the diagnosis status information to a control end (not shown) owned by a parent or a teacher of the learner through the sever end network communication interface 22, such that the parent or teacher of the learner can know the learner's learning assessment situation.

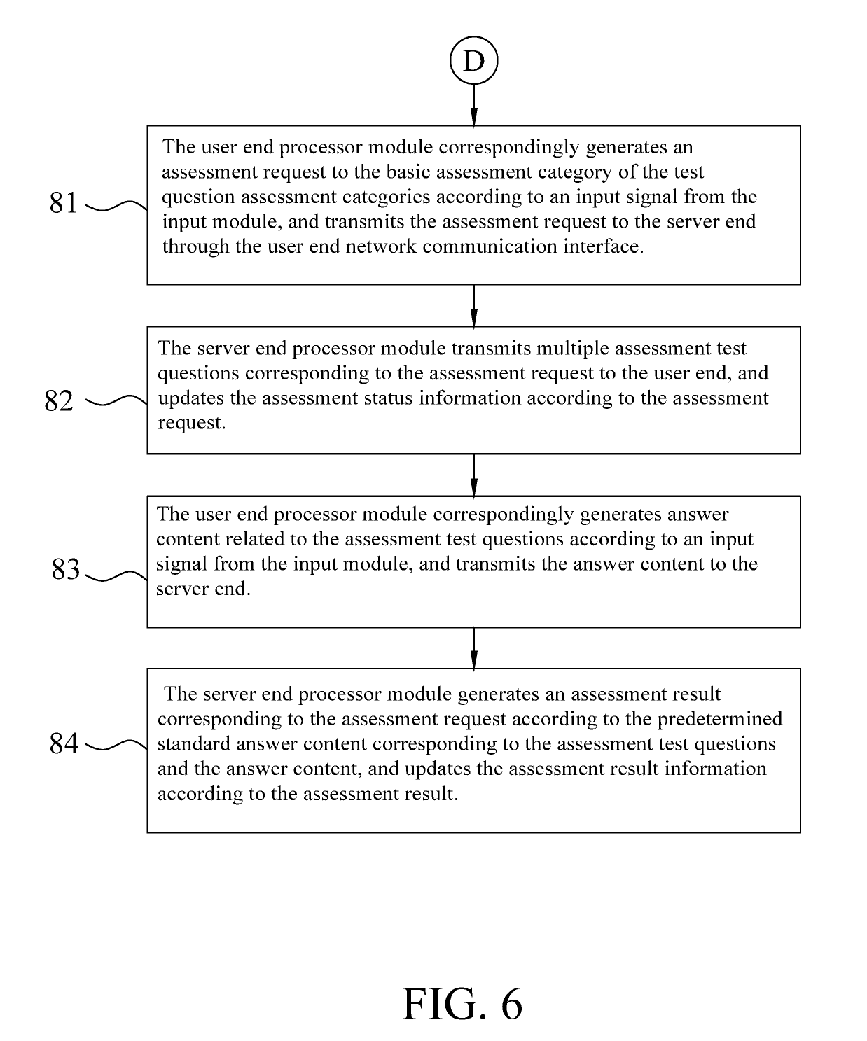

Referring to FIG. 1 and FIG. 6, as shown in step 81, when the course catalog from the server end 2 is received by the user end processor module 16 through the user end network communication interface 15, and the application program is executed for displaying the course catalog on the output module 14, the application program is executed by the user end processor module 16 for correspondingly generating an assessment request to the basic assessment category of the test question assessment categories according to a tenth input signal from the input module 13.

It is to be noted that in this embodiment, only when the diagnostic test questions of the basic diagnosis category have been completely answered by the user end 1, the application program is executed by the user end processor module 16 for generating the assessment request to the basic diagnosis assessment category of the test question assessment categories; however, in other embodiments of the present disclosure, depending on the needs of the learner, the application program can also be directly executed by the user end processor module 16 for generating an assessment request to the basic diagnosis category of the test question diagnosis categories without waiting for that the diagnostic test questions are completely answered, and the present disclosure is not limited to this embodiment.

As shown in step 82, when the assessment request from the user end 1 is received by the server end processor module 23 through the server end network communication interface 22, the learning assessment is executed by the server end processor module 23 for transmitting multiple assessment test questions corresponding to the assessment request to the user end network communication interface 15 through the server end network communication interface 22, and updating the assessment status information according to the assessment request. The assessment status information includes the respective number of the historical assessment requests to each test question assessment category. In this embodiment, the assessment status information is presented by different text notes. For example, when the number of historical assessment requests to the basic assessment category corresponding to the sub-course units is zero, the text note “0 time” is added after the text presented in the basic assessment category; when the number of historical assessment requests to the basic assessment category corresponding to the sub-course units is one, the text note “1 time” is added after the text presented in the basic assessment category, and so on (referring to FIG. 8). However, in other embodiments of the present disclosure, the presentation of the assessment status information can be, but not limited to, text notes or texts with different colors.

It is to be noted that in this embodiment, in step 82, after the assessment status information is updated by the server end processor module 23, the learning assessment program is executed by the server end processor module 23 for transmitting an assessment progress message related to the assessment status information to a control end (not shown) owned by a parent or a teacher of the learner through the server end network communication interface 22 to the user end network communication interface 15, such that the parent or teacher of the learner can know the learning assessment situation.

As shown in step 83, when the assessment test questions are received by the user end processor module 16 through the user end network communication interface 15, and the application program is executed for displaying the assessment test questions on the output module 14, the application program is executed by the user end processor module 16 for correspondingly generating answer content related to the assessment test questions according to an eleventh input signal from the input module 13, and transmitting the answer content to the server end network communication interface 22 through the user end network communication interface 15.

As shown in step 84, when the answer content from the user end 1 is received by the server end processor module 23 through the server end network communication interface 22, the learning assessment program is executed by the server end processor module 23 for generating an assessment result corresponding to the assessment request according to the predetermined standard answer content corresponding to the assessment test questions, the answer content and the predetermined score distribution of the assessment test questions, and updating the assessment result information according to the assessment result, wherein the assessment result is an assessment score. However, in other embodiments of the present disclosure, the learning assessment program is executed by the server end processor module 23 for calculating the ratio (i.e. accuracy rate) of the number of the assessment test questions having the same corresponding answer content as the corresponding predetermined standard answer content to the number of all assessment test questions to be the assessment result. In addition, in this embodiment, the assessment score is also presented in the course catalog (referring to FIG. 8).

It is to be noted that in this embodiment, in step 84, after the assessment result information is updated by the server end processor module 23, the learning assessment program is executed by the server end processor module 23 for transmitting an assessment result message related to the assessment result information to a control end (not shown) owned by a parent or a teacher of the learner through the server end network communication interface 22, such that the parent or teacher of the learner can know the learner's learning assessment situation.

It is to be noted that only when the score of the assessment result of the basic assessment category is higher than 85, the application program can be executed by the user end processor module 16 for correspondingly generating a diagnosis request to the advanced diagnosis category of the test question diagnosis categories according to a twelfth input signal from the input module 13, wherein the diagnosis procedure for the advanced diagnosis category of the test question diagnosis categories performed by the user end processor module 16 is similar to steps 711 to step 725, and thus the detailed descriptions are omitted herein.

In addition, when the score of the assessment result of the basic assessment category is higher than 85, the learning assessment program is executed by the server end processor module 23 for providing a game related to the sub-course unit to the user end 1 through the server end network communication interface 22, such that the learner can be impressed by the concept, which the learner learns, via the game. Further, only when the score of the assessment result of the basic assessment category is higher than 85, the server end processor module 23 provides the game to the learner which inspires the learner to learn more seriously. Similarly, only after the diagnostic test questions corresponding to the advanced diagnosis category have been completely answered, the application program is executed by the user end processor module 16 for correspondingly generating an assessment request to the advanced assessment category of the test question assessment categories according to a thirteenth input signal from the input module 13, wherein the assessment procedure for the advanced assessment category of the test question assessment categories performed by the user end processor module 16 is similar to step 81 to step 84, and thus the detailed descriptions are omitted herein.

Only when the score of the assessment result of the advanced assessment category is higher than 90, the application program can be executed by the user end processor module 16 for correspondingly generating a playback request to the giftedness content category of the course video categories according to a fourteenth input signal from the input module 13, wherein the playback procedure for the course video items of the giftedness content category performed by the user end processor module 16 is similar to step 61 to step 67, and thus the detailed descriptions are omitted herein. In addition, when the score of the assessment result of the advanced assessment category is higher than 90, the learning assessment program is executed by the server end processor module 23 for providing another game related to the sub-course unit to the user end 1 through the server end network communication interface 22, such that the learner can be impressed by the concept, which the learner learns, via the another game. Further, only when the score of the assessment result of the advanced assessment category is higher than 90, the server end processor module 23 provides the another game to the learner which inspires the learner to learn more seriously. Similarly, only when the course video content of the course video items in the giftedness content category has been completely played back by the user end 1, the application program is executed by the user end processor module 16 for correspondingly generating a diagnosis request to the giftedness diagnosis category in the test question diagnosis categories according to a fifteenth input signal from the input module 13, wherein the diagnosis procedure for the giftedness diagnosis category of the test question diagnosis categories performed by the user end processor module 16 is similar to step 711 to step 725, and thus the detailed descriptions are omitted herein. Similarly, only when the diagnostic test questions corresponding to the giftedness diagnosis category have been completely answered, the application program is executed by the user end processor module 16 for correspondingly generating an assessment request to the giftedness assessment category of the test question assessment categories according to a sixteenth input signal from the input module 13, wherein the assessment procedure for the giftedness assessment category of the test question assessment categories performed by the user end processor module 16 is similar to step 81 to step 84, and thus the detailed descriptions are omitted herein. In this embodiment, the assessment result information is presented by different colors of texts (referring to FIG. 7). For example, when the assessment test questions corresponding to the basic assessment category of the sub-course unit have not been transmitted to the user end 1, the text of the sub-course unit is presented by a first color; when the assessment result of the basic assessment category of the sub-course unit is lower than 80, the text of the sub-course unit is presented by a second color; when the assessment result of the basic assessment category of the sub-course unit is higher than 80, the text of the sub-course unit is presented by a third color; when the assessment result of the advanced assessment category of the sub-course unit is lower than 80, the text of the sub-course unit is presented by a fourth color; when the assessment result of the advanced assessment category of the sub-course unit is higher than 80, the text of the sub-course unit is presented by a fifth color; when the assessment result of the giftedness assessment category of the sub-course unit is lower than 80, the text of the sub-course unit is presented by a sixth color; when the assessment result of the giftedness assessment category of the sub-course unit is higher than 80, the text of the sub-course unit is presented by a seventh color. However, in other embodiments of the present disclosure, the presentation of the assessment result information can be, but not limited to, text notes or pattern notes. In addition, it is to be noted that the assessment result information would change along with different test question assessment categories performed by the learner. For example, the learner's assessment result of the basic assessment category is 95; meanwhile, the assessment result information is presented by the third color. When the assessment test questions of the advanced assessment category have been completely answered by the learner and the assessment result corresponding to the advanced assessment category generated by the server end processor module 23 is 90, the assessment result information is presented by the fifth color. When the assessment test questions of the giftedness assessment category have been completely answered by the learner, and the assessment result of the giftedness assessment category generated by the server end processor module 23 is 80, the assessment result information is presented by a seventh color.

It is to be noted that in this embodiment, the diagnosis request to the advanced diagnosis category of the test question diagnosis categories, the assessment request to the advanced assessment category of the test question assessment categories, the playback request to the advanced content category of the course video categories, the diagnosis request to the giftedness diagnosis category of the test question diagnosis categories, and the assessment request to the giftedness assessment category of the test question assessment categories should be performed in sequence. However, in other embodiments of the present disclosure, depending on the needs of the learner, the application program can be directly executed by the user end processor module 16 for generating the above playback request, the diagnosis request and the assessment request in any order, and the present disclosure is not limited to this embodiment.

Accordingly, the course list including the assessment result information related to the sub-course units is displayed at the user end 1, and the assessment result information is updated according to the assessment result, such that the learner can directly browse all assessment results by viewing the course list displayed at the user end 1. Additionally, the course catalog including the playback status information, the diagnosis status information and the assessment status information is displayed at the user end 1, such that the learner can directly know the learning progress by viewing the course catalog at the user end 1. Further, in the sequential procedures of learning, diagnosis and assessment, the learner can learn by playing back the course video, then proceed the test with the diagnostic test questions, wherein when the answer is incorrect, the teaching video is provided to the user to enhance learning, and finally the assessment test questions and the assessment result are provided for the learner to know the outcome of learning. Hence, the present disclosure effectively helps the learner to enhance learning efficacy.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for learning assessment, comprising following steps of:
(A) transmitting login information corresponding to a specific user identity to a server end by a user end through a communication network;
(B) when the login information from the user end is received, transmitting a course list related to at least one subject to the user end by the server end through the communication network, wherein the course list includes a plurality of course units respectively having a plurality of sub-course units and assessment result information corresponding to the specific user identity and related to the sub-course units;
(C) when the course list from the server end is displayed at the user end, generating a learning request to one of the sub-course units by the user end through a first input operation, and transmitting the learning request to the server end through the communication network;
(D) when the learning request from the user end is received, transmitting a course catalog corresponding to the learning request to the user end through the communication network, wherein the course catalog includes a plurality of test question assessment categories;
(E) after the course catalog from the server end is received and displayed at the user end, generating an assessment request to one of the test question assessment categories by the user end through a second input operation, and transmitting the assessment request to the server end through the communication network;
(F) when the assessment request from the user end is received, transmitting a plurality of assessment test questions corresponding to the assessment request to the user end by the server end through the communication network;
(G) when the assessment test questions from the server end are received and displayed by the user end, generating answer content related to the assessment test questions by the user end through a third input operation, and transmitting the answer content to the server end through the communication network; and
(H) when the answer content from the user end is received, generating an assessment result corresponding to the assessment request by the server end according to predetermined standard answer content corresponding to the assessment test questions and the answer content, and updating the assessment result information according to the assessment result.

2. The method for learning assessment according to claim 1, wherein:
in step (D), the course catalog further includes assessment status information related to the test question assessment categories and corresponding to the specific user identity; and
in step (F), the assessment status information is updated by the server end according to the assessment request.

3. The method for learning assessment according to claim 2, wherein the assessment status information includes the respective number of historical assessment requests corresponding to each test question assessment category.

4. The method for learning assessment according to claim 1, wherein in step (D), the course catalog further includes a plurality of course video items, and between step (D) and step (E), the method further includes following steps of:
(I) when the course catalog from the server end is received and displayed by the user end, generating a playback request to one of the course video items by the user end through a fourth input operation, and transmitting the playback request to the server end through the communication network;
(J) when the playback request from the user end is received, transmitting course video content corresponding to the playback request to the user end by the server end through the communication network; and
(K) when the course video content from the server end is received, starting to play back the course video content by the user end.

5. The method for learning assessment according to claim 4, wherein in step (D), the course catalog further includes playback status information related to the course video items and corresponding to the specific user identity, and between step (K) and step (E), the method further includes following steps of:
(L) determining by the server end according to transmission situation of the course video content whether the course video content is completely played back by the user end to generate a first determination result; and
(M) updating the playback status information by the server end according to the first determination result.

6. The method for learning assessment according to claim 5, wherein in step (D), the course catalog further includes a plurality of test question diagnosis categories, and between step (M) and step (E), the method further includes following steps of:
(N) when the server end determines in step (L) that the course video content is completely played back by the user end, generating a diagnosis request to one of the test question diagnosis categories by the user end through a fifth input operation, and transmitting the diagnosis request to the sever end through the communication network;
(O) when the diagnosis request from the user end is received, transmitting diagnostic test questions related to the diagnosis request to the user end by the server end;
(P) when the diagnostic test questions from the server end are received, generating answer content related to the diagnostic test questions by the user end through a sixth input operation, and transmitting the answer content to the server end through the communication network; and
(Q) when the answer content from the user end is received, determining by the server end according to a standard answer corresponding to the diagnostic test questions whether the answer content is correct.

7. The method for learning assessment according to claim 6, wherein when a second determination result indicates that the answer content is correct, step (E) is performed.

8. The method for learning assessment according to claim 6, wherein between step (Q) and step (E), the method further includes following steps of:
(R) when the second determination result indicates that the answer content is incorrect, transmitting a teaching video related to the diagnostic test questions in step (0) to the user end by the server end through the communication network, such that the teaching video is played back by the user end; and
(S) when the teaching video is completely played back by the user end, repeating step (O) to step (Q) once;
wherein when the second determination result generated in step (S) indicates that the answer content is correct, step (E) is performed.

9. The method for learning assessment according to claim 1, wherein in step (D), the course catalog further includes a plurality of test question diagnosis categories, and between step (D) and step (E), the method further includes following steps of:
(T) when the course catalog from the server end is received and displayed by the user end, generating a diagnosis request to one of the test question diagnosis categories by the user end through a seventh input operation, and transmitting the diagnosis request to the server end through the communication network;
(U) when the diagnosis request from the user end is received, transmitting a diagnostic test questions related to the diagnosis request to the user end by the server end;
(V) when the diagnostic test questions from the server end are received, generating answer content related to the diagnostic test questions by the user end through an eighth input operation, and transmitting the answer content to the server end through the communication network; and
(W) when the answer content from the user end is received, determining by the server end according to a standard answer corresponding to the diagnostic test questions whether the answer content is correct.

10. The method for learning assessment according to claim 9, wherein between step (W) and step (E), the method further includes following steps of:
(X) when a determination result indicates that the answer content is incorrect, transmitting a teaching video related to the diagnostic test questions in step (U) to the user end by the server end through the communication network, such that the teaching video is played back by the user end; and
(Y) when the teaching video is completely played back by the user end, repeating step (U) to step (W) once.

11. The method for learning assessment according to claim 1, wherein the login information is obtained by the user end using a QR code corresponding to the login information.
